(19) United States
(12) Patent Application Publication
(10) Pub. No.: US 2018/0189398 A1
(43) Pub. Date: Jul. 5, 2018

(54) COGNITIVE AND AFFECTIVE HUMAN MACHINE INTERFACE

(71) Applicant: IOT Holdings, Inc., Wilmington, DE (US)

(72) Inventors: Gregory S. Sternberg, Mt. Laurel, NJ (US); Yuriy Reznik, Seattle, WA (US); Ariela Zeira, Huntington, NY (US); Shoshana Loeb, Philadelphia, PA (US); John D. Kaewell, Jamison, PA (US)

(73) Assignee: IOT Holdings, Inc., Wilmington, DE (US)

(21) Appl. No.: 15/120,625

(22) PCT Filed: Feb. 23, 2015
(86) PCT No.: PCT/US2015/017093

§ 371 Date: Aug. 22, 2016

Related U.S. Application Data
(60) Provisional application No. 61/943,467, filed on Feb. 23, 2014.

(51) Int. Cl. G06F 17/30; G06Q 30/02; G06F 3/01; G09B 5/06; G09B 5/12; A63F 13/213; A63F 13/85; A63F 13/212; A63F 13/67

(52) U.S. Cl. CPC G06F 17/30867; G06Q 30/0264; G06Q 30/0269; G06F 3/015; G06Q 30/0255; A63F 13/67; G09B 5/125; A63F 13/213; A63F 13/85; A63F 13/212; G09B 5/065

(57) ABSTRACT

Cognitive, emotional and/or affective state information may be used for adaptive gaming, advertisement insertion delivery timing, driver or pilot assistance, education, advertisement selection, product and/or content suggestions, and/or video chat applications. A human machine interface (HMI) may be generated. A content placement in the HMI may be managed. Sensor data from one or more sensors may be received. A timing for delivery of content may be determined. The timing for delivery of the content may be determined based on at least one of the determined cognitive state of the user or the determined affective state of the user. The content may be selected for delivery to the user based on at least one of the cognitive state of the user or the affective state of the user. The content may include an advertisement.

### CROSS REFERENCE TO RELATED APPLICATIONS

This application claims the benefit of U.S. Provisional Patent Application No. 61/943,467, filed Feb. 23, 2014; the contents of which are incorporated by reference herein.

### BACKGROUND

Some human machine interfaces (HMIs) may overwhelm or frustrate the user. For example, in the case of inappropriately-timed advertisement insertions, or overly challenging or boring games, customers may be alienated. In automobile collision alert systems, safety may be an issue if an HMI is distracting the user with low-priority messages while also issuing alerts of impending danger. In the field of marketing, the effectiveness of the marketing may be reduced by poor timing and/or messaging. Some approaches to making suggestions to consumers regarding products or content may use inferential data that may not be a good predictor of actual product or content enjoyment or interest. The ability of students to learn material in education settings may be reduced as teachers or computer-based training may progress without regard to the student's ability to process new information. Progressing through a lesson this way may result in a loss of efficiency.

### SUMMARY

Systems, methods, and instrumentalities are disclosed for generating a human machine interface (HMI) that may be aware of and that may adapt to the user's cognitive load and/or emotional affective state. Sensor data may be used to estimate a cognitive state (e.g., cognitive load) and/or affective state of a user, which may be used to prioritize or otherwise affect interactions with the user. The cognitive and/or affective state of the user may include information other than what can be inferred from the context and/or from content that has already been consumed. For example, cognitive and/or affective state information may be used for adaptive gaming, advertisement placement and/or delivery timing, driver or pilot assistance, education, advertisement selection, product and/or content suggestions, and/or video chat applications.

A system may generate a human machine interface (HMI). The system may manage a content placement in the HMI. The system may deliver content to a user. The content may include video data, video game data, educational data, training data, or the like. The system may receive sensor data from one or more sensors. The sensor data may be associated with a user. The sensor data from the one or more sensors may include at least one of camera data, galvanic skin response (GSR) data, voice analysis data, facial expression analysis data, body language analysis data, eye movement and gaze tracking analysis data, blink rate analysis data, electroencephalographic data, electrodermal activity data, pupillometry data, heart rate data, blood pressure data, respiration rate data, or body temperature data. The system may determine at least one of a cognitive state or an affective state of the user based on the received sensor data. The cognitive state of the user may include a cognitive load of the user. The affective state of the user may include an arousal measure and a valence measure. The system may analyze the received sensor data. The system may plot the arousal measure and the valence measure on a two-dimensional arousal valence space. The system may associate the user with one or more predefined affective states based on the plot.

The system may determine a timing for delivery of content. The content may include an advertisement. The timing for delivery of the content may be determined based on at least one of the determined cognitive state of the user or the determined affective state of the user. The content may be delivered to the user when the cognitive load of the user is below a predetermined threshold or when the affective state of the user indicates that the user is receptive. The affective state of the user may indicate that the user is receptive when a distance measure from the affective state of the user to a predefined affective state is below a predetermined threshold. The predefined affective state may include a predefined arousal measure and a predefined valence measure. The distance measure may be based on a distance between the affective state of the user and the predefined affective state. The distance measure may include an arousal component and a valence component. The content may be delivered to the user based on the determined timing. The content may be delivered to the user via the HMI or a second HMI.

The system may select the content for delivery to the user. The content may be selected for delivery to the user based on at least one of the cognitive state of the user or the affective state of the user. The content may be selected for delivery to the user based on a stimulus response model for the user. The stimulus response model may be based on historical user responses to (e.g., historical observations of a user's cognitive and/or affective state in response to) prior content. The user may be associated with a customer category. The user may be associated with the customer category based on a stimulus/response pair. The stimulus/response pair may be based on information presented to the user and at least one of the cognitive state or the affective state of the user in response to the information presented. The system may store the stimulus/response pair. The content may be selected for delivery to the user based on the customer category associated with the user. The content may be selected for delivery to the user based on a stimulus response database of customers in a predefined customer category. The predefined customer category may include the user. The content may be a first advertisement for a first product. The first advertisement for the first product may be selected based on a previous response of the user to a second advertisement for a second product.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and another example core network that may be used within the communications system illustrated in FIG. 1A.

FIG. 1E is a system diagram of another example radio access network and another example core network that may be used within the communications system illustrated in FIG. 1A.

FIG. 2 is a diagram illustrating an example relationship between pupil dilation and memory encoding difficulty.

FIG. 3 is a diagram illustrating an example two-dimensional space that may be used to categorize affective states.

FIG. 4 is a block diagram illustrating an example affective- and/or cognitive-adaptive gaming system.

FIG. 5 is a block diagram illustrating an example affective- and/or cognitive-adaptive advertisement delivery timing system.

FIG. 6 is a block diagram illustrating an example affective- and/or cognitive-adaptive alert system.

FIG. 7 is a block diagram illustrating an example affective- and/or cognitive-adaptive education system.

FIG. 8 is a block diagram illustrating an example affective- and/or cognitive-adaptive product or content suggestion system.

FIG. 9 is a block diagram illustrating an example of customer categorization.

FIG. 10 is a block diagram illustrating an example of product/content suggestion.

FIG. 11 is a block diagram illustrating an example affective- and/or cognitive-adaptive video chat system.

FIG. 12 is a block diagram illustrating an example subsystem that may populate a state/interpretation database with training data that may link cognitive and/or affective states with interpretations.

FIG. 13 is a block diagram illustrating an example video annotation generation subsystem.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

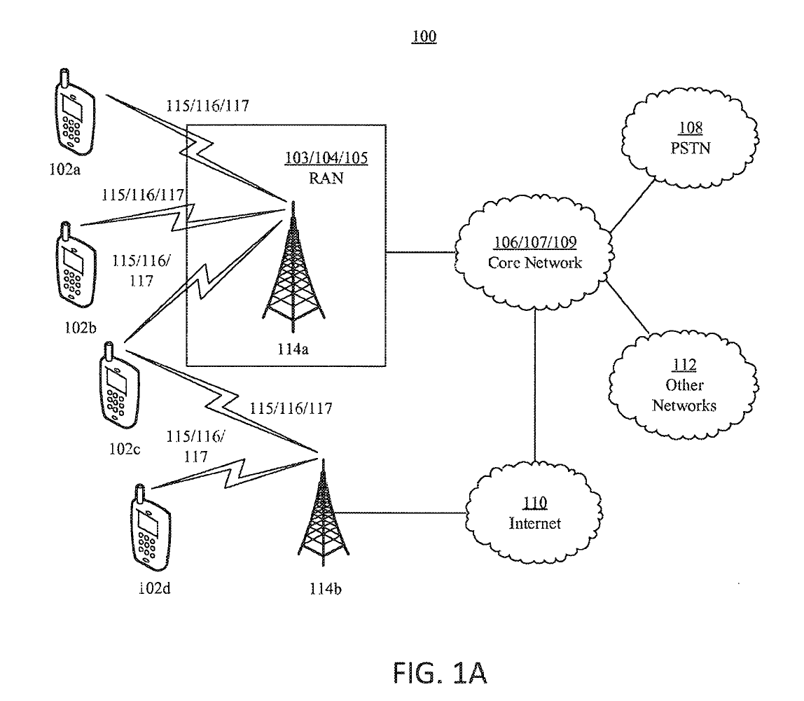

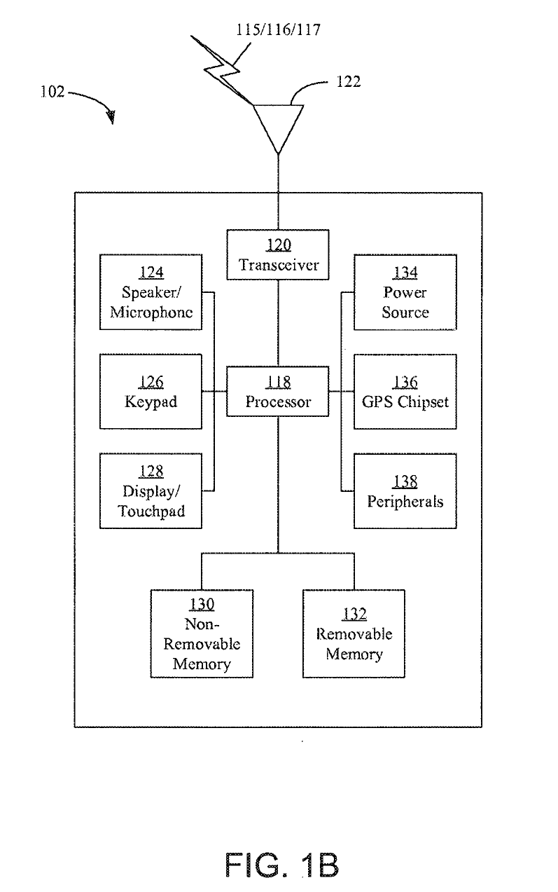

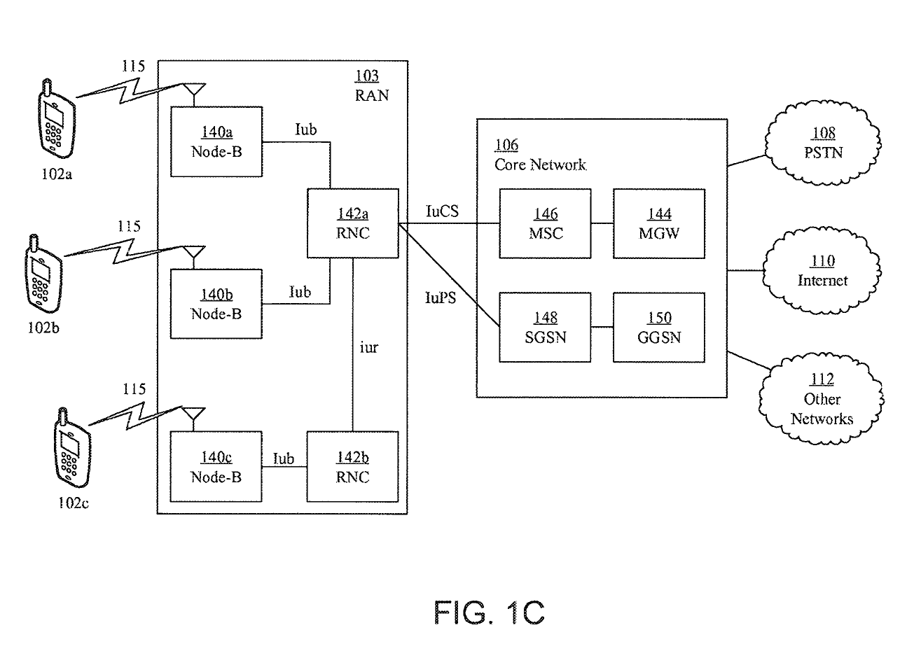

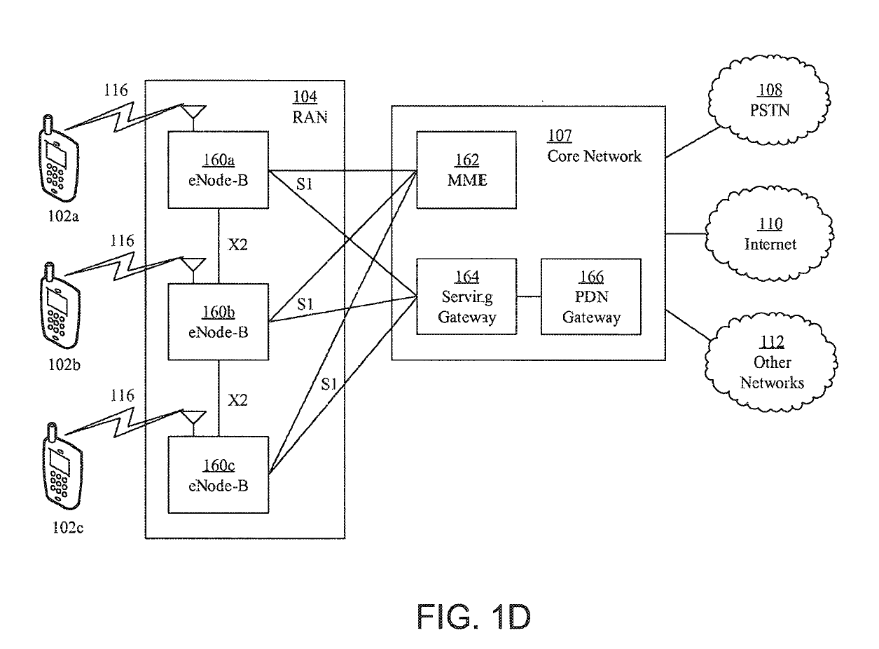

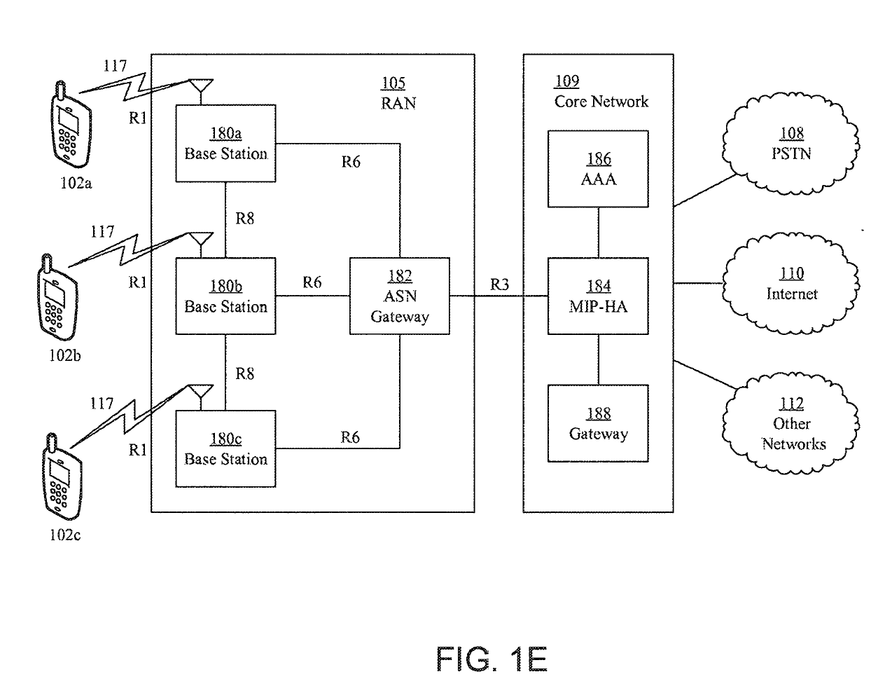

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications system 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB or HeNodeB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination implementation while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

A human-machine interface (HMI) may receive data (e.g., sensor data) from one or more sensors. The HMI may determine, based on the received sensor data, a cognitive state of a user and/or an affective state of the user. The HMI may adapt to the cognitive state and/or affective state of the user. The HMI may deliver content to the user. The content may be delivered to the user via a WTRU 102 (e.g., a smart phone handset or a tablet computer, etc.) as depicted in FIG. 1A through FIG. 1E. The WTRU 102 may include a processor 118 and a display 128, as depicted in FIG. 1B. Systems 400, 500, 600, 700, 800, 900, 1000, 1100, 1200 and 1300, as disclosed herein, may be implemented using a system architecture such as the systems illustrated in FIG. 1C through FIG. 1E. The content may include video data, video game data, educational data, and/or training data.

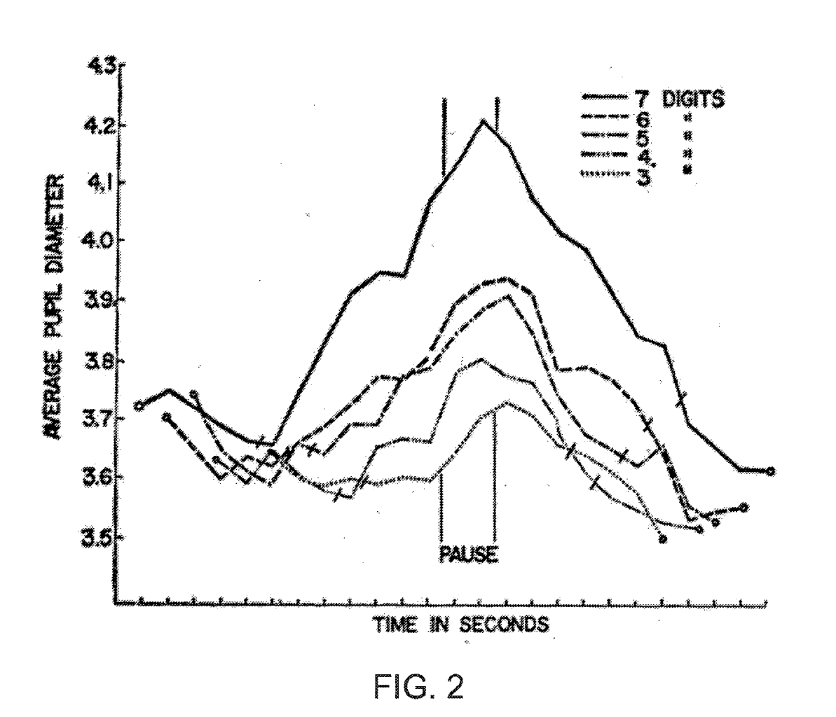

One or more (e.g., multiple) signals may be captured that may correlate to cognitive load and/or affective state. The one or more signals may include sensor data received from one or more sensors. For example, pupil dilation may be associated with cognitive effort. A change in pupillary dilation elicited by psychological stimuli may be on the order of 0.5 mm. The chance in pupillary dilation may occur as the result of a neural inhibitory mechanism by the parasympathetic nervous system. FIG. 2 is a diagram illustrating example results of a study in which subjects' pupil diameters were measured while the subjects encoded memories with varying levels of difficulty. With reference to FIG. 2, encoding a memory may be correlated with an increase in pupil diameter. A level of difficulty of the encoded memory may correlate with a magnitude of the increase in pupil diameter.

There may be a number of approaches for measuring cognitive loading and/or affective state with varying levels of invasiveness. The approaches for measuring cognitive loading and/or affective state may include, galvanic skin response (GSR) or electrodermal activity, voice analysis, facial expression analysis, body language analysis, eye movement and gaze tracking, blink rate analysis, heart rate analysis, blood pressure analysis, respiration rate analysis, body temperature analysis, and/or electroencephalography. Cognitive load and/or affective state estimation (e.g., determination) may be performed using one or more of the approaches for measuring cognitive loading and/or affective state (e.g., depending on the setting and feasibility of obtaining the data).

Affective computing may include the study and development of systems and/or devices that can recognize, interpret, process, and/or simulate human affects. Affective computing may be an interdisciplinary field spanning at least computer science, psychology, and/or cognitive science. A machine may interpret an emotional state of a human. The machine may adapt a behavior to the emotional state of the human. The machine may provide an appropriate response to the emotional state of the human.

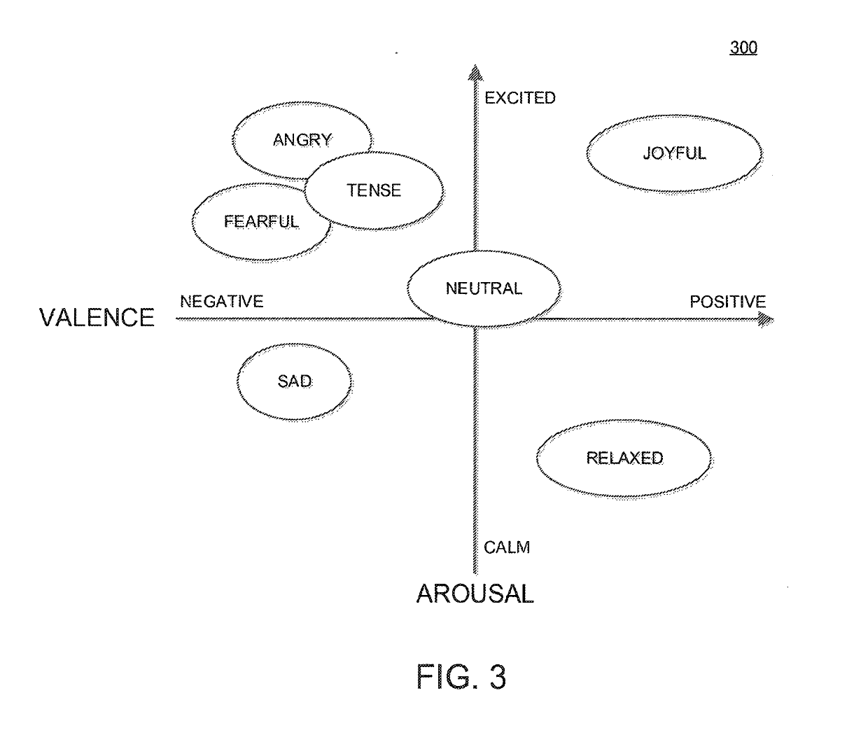

An affective state may be categorized into one or more predefined affective states. The affective state may be categorized in a space, as shown by way of example in FIG. 3. The one or more predefined affective states may enable decision making based on an estimate of human affect. FIG. 3 is a diagram illustrating an example two-dimensional space 300 that may be used to categorize affective states by plotting arousal against valence. The two-dimensional space may include one or more predefined affective states. The two-dimensional space may include an arousal axis that is perpendicular to a valence axis. A predefined affective state may be defined by an arousal measure and a valence measure. The arousal measure may include a first distance from the arousal axis. The valence measure may include a second distance from the valence axis. The one or more predefined affective states may include angry, tense, fearful, neutral, joyful, sad, and/or relaxed. For example, an angry predefined affective state may include a negative valence measure and an excited arousal measure. As another example, a tense predefined affective state may include a moderate negative valence measure and a moderate excited arousal measure. As another example, a fearful predefined affective state may include a negative valence measure and a moderately excited arousal measure. As another example, a neutral predefined affective state may include a slightly excited or calm valence measure and a slightly positive or negative arousal measure. As another example, a joyful predefined affective state may include a positive valence measure and an excited arousal measure. As another example, a sad predefined affective state may include a negative valence measure and a calm arousal measure. As another example, a relaxed affective state may include a positive valence measure and a calm arousal measure. Arousal may be a physiological and/or psychological state of being awake and/or reactive to stimuli. Valence may be a measure of an attractiveness (e.g., positive valence) of or an aversiveness (e.g., negative valence) to an event, object, or situation.

Arousal and/or valence may be tracked. For example, arousal and/or valence may be tracked via speech analysis, facial expression analysis, body language analysis, electroencephalography, galvanic skin response (GSR) or electrodermal activity (e.g., a measure of activity of the sympathetic nervous system, e.g., fight or flight response), tremor or motion analysis, pupillometry, eye motion/gaze analysis, blink rate analysis, heart rate analysis, blood pressure analysis, respiration rate analysis, and/or body temperature analysis. One or more predefined affective states may be determined and may be plotted on a two-dimensional space plotting arousal and valence. A predefined affective state may be concurrent with one or more predefined affective states. An arousal measure and a valence measure for the user may be determined at various times. At the various times, the arousal measure and the valence measure may be measured and/or plotted on the two-dimensional arousal valence space.

A game designer (e.g., a video game designer) may attempt to achieve a balance between making games challenging (e.g., overly challenging), which may frustrate a user, and making games easy (e.g., overly easy), which may bore the user. Sensor data may be captured using gaming platforms that incorporate cameras, accelerometers, motion trackers, gaze trackers, and/or the like. The sensor data may be analyzed to determine an affective and/or cognitive state of the user. Analyzing the sensor data may include analyzing one or more video images captured of a user along with other sensor input data, such as GSR, tremor, body language, and/or facial expressions. Game content may be adjusted based on the determined affective and/or cognitive state (e.g., to increase or maximize the user's engagement and/or reduce or minimize attrition).

For example, game content may be adapted by reducing the level of difficulty when a user's valence and arousal measures indicate excessive anger with the game play. If pupillometric estimates indicate that the user is saturated and/or unable to encode memories, game content may be adjusted based on the pupillometric estimates. A system may approach this trade-off in an open-loop fashion. For example, after a user attempts to achieve an objective more than a threshold number of times, the system may provide the user with a hint or another form of assistance. A closed-loop approach may be more tuned to the user's response to the game content. Some systems may allow the user to select a level of difficulty for the game. An adaptive difficulty mode may base the level of difficulty on the user's measured affective and/or cognitive state. The system may offer assistance and/or hints as the affective and/or cognitive state may indicate that such assistance may improve the user's gaming experience. Adaptive difficulty may be enabled or disabled, for example, based on user preferences.

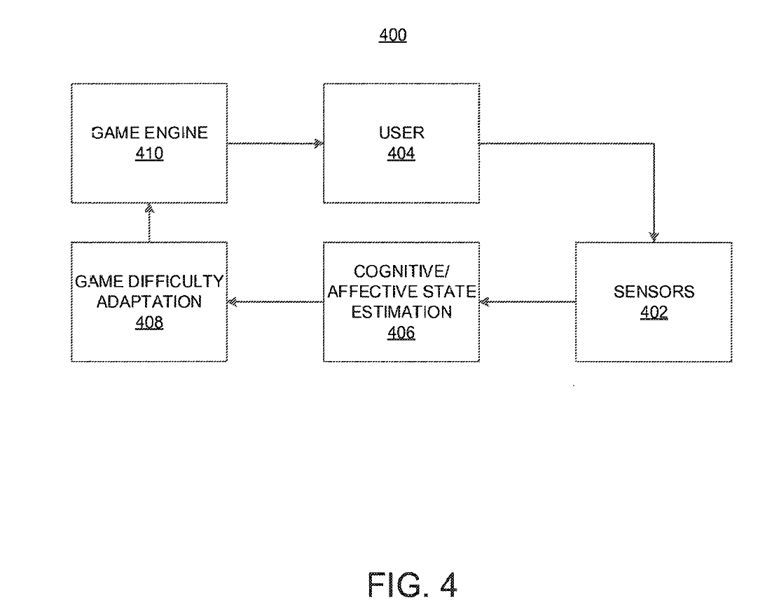

FIG. 4 is a block diagram illustrating an example flow of information in an example affective- and/or cognitive-adaptive gaming system 400. One or more sensors 402 may obtain data (e.g., sensor data) associated with a user 404. The one or more sensors 402 may provide the data for a cognitive/affective state estimation, at 406. The cognitive/affective state estimation, at 406, may use the data to determine (e.g., estimate) the user's cognitive and/or affective state. The cognitive state of the user may include the cognitive load of the user. The determined user cognitive and/or affective state information may be provided for a game difficulty adaptation, at 408. The game difficulty adaptation, at 408, may adjust the difficulty level of the game and/or determine hints and/or other assistance to provide to the user based on the determined cognitive and/or affective state of the user. Adjustments implemented by the game difficulty adaptation, at 408 may be performed by a game engine 410. The game engine 410 may present the game experience to the user 404.

A timing for delivery (e.g., insertion) of content (e.g., one or more advertisements) may be determined. The timing for delivery may increase (e.g., maximize) an impact of the one or more advertisements. An affective and/or cognitive state of a user may be used to influence advertisement placement (e.g., a timing for delivery). If advertisements are inserted at the wrong time (e.g., when the user is saturated with other activities) during a user's session, the marketing message may be lost, or an advertisement may be bypassed. By tracking a user's affective and/or cognitive state, a system may insert advertisements at a time that may increase or maximize the efficacy of the message delivery and/or reduce or minimize the frequency of advertisement bypasses (e.g., “skip the ad” clicks). An adjustment to the timing of delivery may not impact the overall rate of advertisement insertions. The adjustment to the timing of delivery may optimize the timing of the insertion. For example, a time window may include a duration of time during which an advertisement may be inserted. The timing of the advertisement delivery within the time window may be determined based on the user's cognitive and/or affective state. The advertisement may be inserted at a particular time within the window based on the detection of a receptive cognitive state and/or a receptive affective state of the user at the particular time within the window. The advertisement may be inserted at or toward the end of the time window on a condition that the affective and/or cognitive state of the user did not trigger an advertisement insertion earlier in the time window. A content viewing timeline may be overlaid with or partitioned into one or multiple such time windows such that one or multiple advertisements are inserted as the user views the content. For example, an hour long video program (or an hour of video viewing, even if not a single video program) may be partitioned into five time windows of twelve minutes each, and the cognitive and/or affective state of the user may be used to adjust the timing of delivery (e.g., insertion) of an advertisement into each of the five time windows. In this way an advertiser may time the delivery of advertisements to coincide with receptive cognitive and/or affective states of the user, while maintaining a pre-determined overall rate of advertisement insertion (e.g., five advertisements per hour). The time window may be combined with a normalized peak detector. The normalized peak detector may determine an affective and/or cognitive state normalization based on a moving average of the affective and/or cognitive state of the user. A threshold affective and/or cognitive state for advertisement placement may adapt to a user with a lower average response.

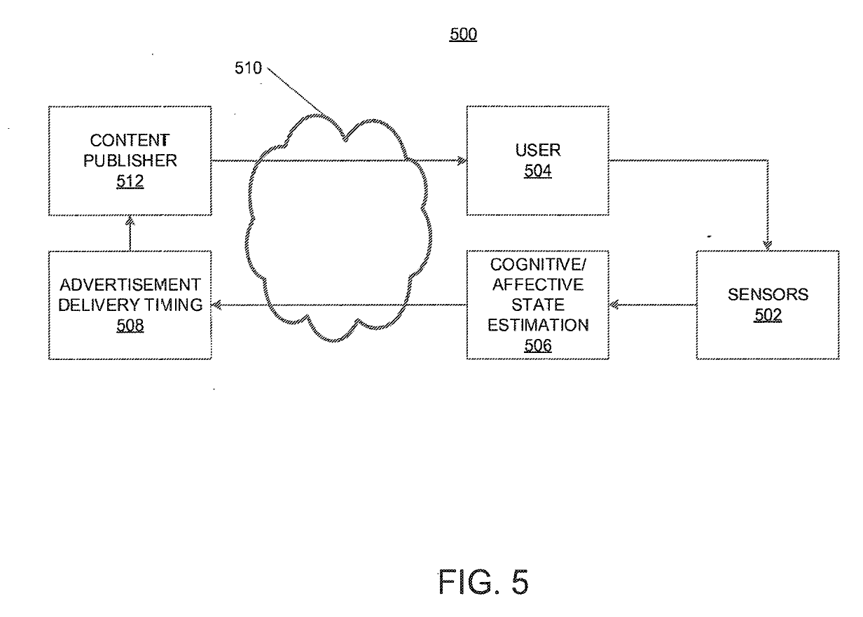

FIG. 5 is a block diagram illustrating an example flow of information in an example affective- and/or cognitive-adaptive advertisement insertion timing system 500. One or more sensors 502 may obtain data (e.g., sensor data) associated with a user 504. The one or more sensors 502 may provide the data for a cognitive/affective state estimation 506. The cognitive/affective state estimation subsystem 506 may use the data to determine (e.g., estimate) a cognitive and/or affective state of the user 504. For example, an arousal and a valence of the user may be determined based on the data. The arousal and the valence of the user 504 may be plotted on a two-dimensional arousal and valance space. The affective state of the user 504 may be determined based on the plotted arousal and valence of the user 504. The user may be associated with one or more predefined affective states based on the plot of arousal and valence. The cognitive state of the user 504 may be determined based on the data. The cognitive state of the user 504 may include the cognitive load of the user 504.

The determined cognitive and/or affective state of the user 504 may be provided for an advertisement delivery timing, at 508. The cognitive/affective state estimation 506 may be provided via a network 510. The advertisement delivery timing, at 508, may determine a timing for delivery (e.g., schedule insertion) of one or more advertisements based on the determined cognitive and/or affective state of the user 504. An advertisement insertion may be triggered when the user is receptive. For example, an advertisement may be delivered to the user when the user is receptive. The affective state of the user may indicate when the user is receptive. For example, a distance measure from the affective state of the user to a predefined affective state may be determined. The predefined affective state may include a predefined arousal measure and a predefined valence measure. When the distance measure from the affective state of the user to a predetermined affective state is below a predetermined threshold, the user may be receptive. The user may be receptive when the user may be exhibiting moderately high arousal and high valence. An advertisement may be delivered to the user when a cognitive load of the user is below a predetermined threshold. The cognitive load of the user may be below a predetermined threshold when the user is able to encode new memories.

The determined timing for delivery of the one or more advertisements, at 508, may be provided to a content publisher 512. The content publisher 512 may deliver the one or more advertisements and/or other content to the user 504 based on the determined timing. The affective- and/or cognitive-adaptive advertisement insertion timing system 500 may be implemented using a system architecture such as the systems depicted in FIG. 1C through FIG. 1E. For example, the advertisement and/or the content may be delivered to the user via a WTRU 102 (e.g., a smart phone handset or a tablet computer, etc.) as depicted in FIG. 1C through FIG. 1E. By monitoring the user's cognitive load and triggering (e.g., delivering) the advertisement when the user may be able to encode new memories, retention of the advertisement's marketing message may be increased or maximized. A likelihood that the user's behavior may be changed by the advertisement marketing message may be increased when the advertisement is delivered when the cognitive load of the user is below a predetermined threshold.

An affective and/or cognitive state of a user may be used to assist drivers and/or pilots. The cognitive state of the user may be given more weight than the affective state of the user (e.g., cognitive processing may be more important than affective state). Adaptation of infotainment systems may leverage affective state estimation as disclosed herein. For example, music may be suggested to a driver based on the affective state of the driver.

Drivers or pilots may become distracted or saturated with lower priority interface alerts and may miss high priority messages, such as collision alerts. The cognitive load of the user may be monitored, for example, via pupillometry (e.g., using a rear-view mirror or dashboard mounted camera), GSR (e.g., using GSR sensors incorporated in the steering wheel or aircraft yoke), voice analysis (e.g., as captured by a vehicle communications system), and/or information from a vehicle navigation system (e.g., based on GPS, etc.). These inputs may be synthesized into a cognitive load assessment that may be used to provide one or more triggers (e.g., dynamic triggers, for user interface alerts). For example, if the fuel level is dropping below a threshold, an alert may be timed for delivery to avoid distraction and/or allow the driver to maintain focus on higher priority tasks, such as avoiding collisions. The alert may be timed for delivery in a prioritized manner based on a cognitive and/or affective state of a driver or pilot. The prioritized manner may enable one or more critical alerts to be processed immediately (e.g., without delay). A lower priority alert, in the prioritized manner, may be delivered while a cognitive bandwidth (e.g., cognitive load) of the driver or pilot enables the driver or pilot to focus on the lower priority alert. The vehicle navigation system may be used to keep track of key points on a route and/or to trigger alerts of upcoming maneuvers.

Cognitive loading may provide an input to the timing of one or more user interface messages. For example, if the driver or pilot is (e.g., according to a preplanned navigation route or a flight plan) approaching a location that may involve the execution of a maneuver, such as an exit from a highway or a vector change, the HMI may deliver one or more nonessential messages while monitoring cognitive load and may provide one or more indications based on the cognitive load of the user. For example, if pupillometric and/or galvanic skin response (GSR) measurements indicate that the driver or pilot is not saturated with mental activity, in advance of a critical maneuver, the interface may indicate the presence of a lower priority interrupt, e.g., maintenance reminders, etc. As another example, if pupillometric and/or GSR measurements indicate that the driver or pilot may be saturated with mental activity, the interface may omit or delay indicating the presence of lower priority interrupts.

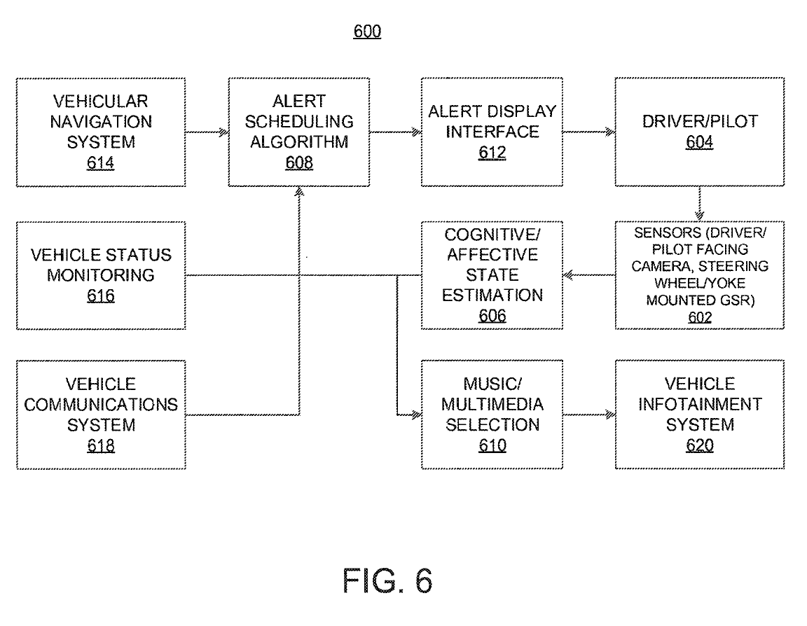

FIG. 6 is a block diagram illustrating an example flow of information in an example affective- and/or cognitive-adaptive alert system 600. One or more sensors 602 (e.g., a driver or pilot facing camera, steering wheel or yoke-mounted GSR sensor, etc.) may obtain data associated with a driver or a pilot 604. The one or more sensors 602 may provide the data for a cognitive/affective state estimation, at 606. The cognitive/affective state estimation, at 606, may include using the data to determine (e.g., estimate) a cognitive and/or affective state of the driver or the pilot 604. The cognitive state of the driver or the pilot 604 may include the cognitive load of the driver or the pilot 604. The determined cognitive and/or affective state may be provided for an alert scheduling, at 608, and/or a music or multimedia selection, at 610. The alert scheduling, at 608, may determine a timing for delivery of one or more alerts for presentation on an alert display interface 612. The timing for delivery of the one or more alerts may be based on the determined cognitive and/or affective state of the driver or pilot 604, information from a vehicular navigation system 614, information from a vehicle status monitoring 616, and/or information from a vehicle communications system 618. The music or multimedia selection, at 610, may select music and/or multimedia content for the driver or pilot 604 based on the determined affective state of the driver or pilot 604. The selected music and/or multimedia content may be delivered to the driver or pilot 604 via a vehicle infotainment system 620.

Affective and/or cognitive stale may be used in educational settings, such as computer-based training sessions and/or a classroom environment (e.g., a live classroom environment). One or more cues may be used to determine student engagement and retention. The one or more cues may be used to control the flow of information and/or the timing of breaks in the flow of information. A cognitive and/or affective state of a student may be used to determine a timing for (e.g., pace) the presentation of material. The cognitive state of the student may include the cognitive load of the student. The cognitive and/or affective state of the student may be used as a trigger for repetition and/or reinforcement. For example, if the first presentation of a topic results in a negative affect (e.g., high arousal and negative valence), the topic may be clarified and/or additional examples may be provided. The cognitive and/or affective state of the student may be used by a teacher (e.g., a live teacher) or in the context of computer-based training. For example, an ability of a student to absorb material may be calculated based on the cognitive and/or affective state of the student. As another example, the timing of a break (e.g., appropriate breaks) may be calculated based on the cognitive and/or affective state of the student. The computer-based or live training system may monitor one or more students in a class. The computer-based or live training system may provide one or more indications (e.g., reports) of the cognitive and/or affective states of the one or more students. For example, the one or more indications may be presented to a teacher in a live classroom via an HMI during the class. Based on the cognitive and/or affective state of the one or more students, the computer-based or live training system may determine an efficacy of a rate (e.g., a current rate) of teaching and/or may monitor incipient frustrations that may be developing. In the live training (e.g., classroom) system, the teacher may be presented (e.g., via an HMI) with a recommendation to change the teaching pace, to spend additional time to reinforce material associated with low (e.g., poor) cognitive and/or affective states, and/or to spend additional time with one or more students identified as having a low (e.g., poor) cognitive and/or affective state. In the computer-based training (e.g., learning) system, the teaching pace (e.g., the pace of the lessons) may be adjusted, and/or the reinforcement of material for a student may be triggered automatically in response to detection of a low (e.g., poor) cognitive and/or affective state of the student.

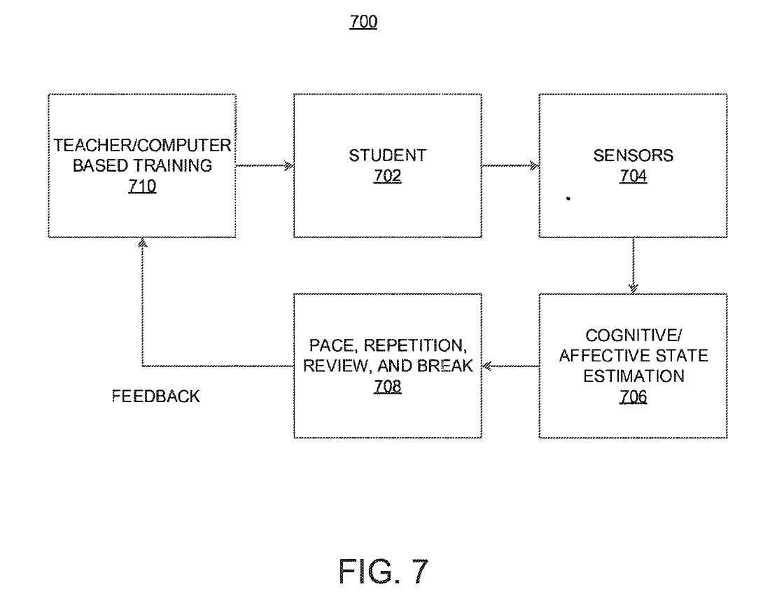

FIG. 7 is a block diagram illustrating an example flow of information in an example affective- and/or cognitive-adaptive education system 700. For computer-based training, a student 702 may be located in close proximity to a computer. Cognitive and/or affective state tracking of the student 702 may be performed via one or more sensors 704, such as a front facing camera. The one or more sensors 704 may provide data (e.g., sensor data) associated with the student 702 to a cognitive/affective state estimation, at 706. At 706, the cognitive/affective state estimation may estimate (e.g., determine) a cognitive and/or affective state of the student 702 based on the sensor data. The determined cognitive and/or affective state of the user may be provided to analyze an efficacy of a pace, a repetition, a review, and/or a break. At 708, the pace, repetition, review, and break analysis may indicate to a teacher or computer-based training subsystem 710 whether to increase or decrease a pace of information flow and/or whether to review a previous topic. The cognitive and/or affective state tracking input may be used to time breaks in the training (e.g., to provide the students with time to rest and be able to return to the training session with a better attitude and with a restored level of cognitive resources). For a live classroom setting, the affective- and/or cognitive-adaptive education system 700 may provide an indication of student reception on a display (e.g., a heads up display (HUD) that may be visible to a teacher during the course of a class). In a classroom (e.g., a live classroom) setting, one or more sensors 704 may be used to track the cognitive load of one or more students. The one or more sensors 704 may be mounted at the front of the classroom. The one or more sensors 704 may track the faces of the one or more students. The one or more sensors 704 may include one or more telephoto lenses. The one or more sensors 704 may use electromechanical steering (e.g., to provide sufficient resolution for pupillometric measurements).

Affective and/or cognitive state may be used for product suggestion (e.g., advertisement selection). A content provider may provide a user with a suggestion based on feedback (e.g., explicit feedback). The feedback may include a click of a “like” button and/or prior viewing choices by the user. A retailer may suggest (e.g., select for delivery) one or more products based on a browsing and/or purchase history of the user. The cognitive and/or affective state of the user may be tracked (e.g., to facilitate selecting advertisements for products and/or content that the user may enjoy). For example, when the user exhibits a high level of arousal (e.g., a high arousal measure) and positive valence (e.g., joyfulness) following the presentation (e.g., delivery) of a certain type of video, audio, or product, the retailer may select a product for delivery that has historically elicited positive affective responses from similar users. Similar users may include users who have had similar affective responses to content as the current user of interest. Users who have had similar responses can be used as proxies for the expected response of the current (e.g., target) user to new content.

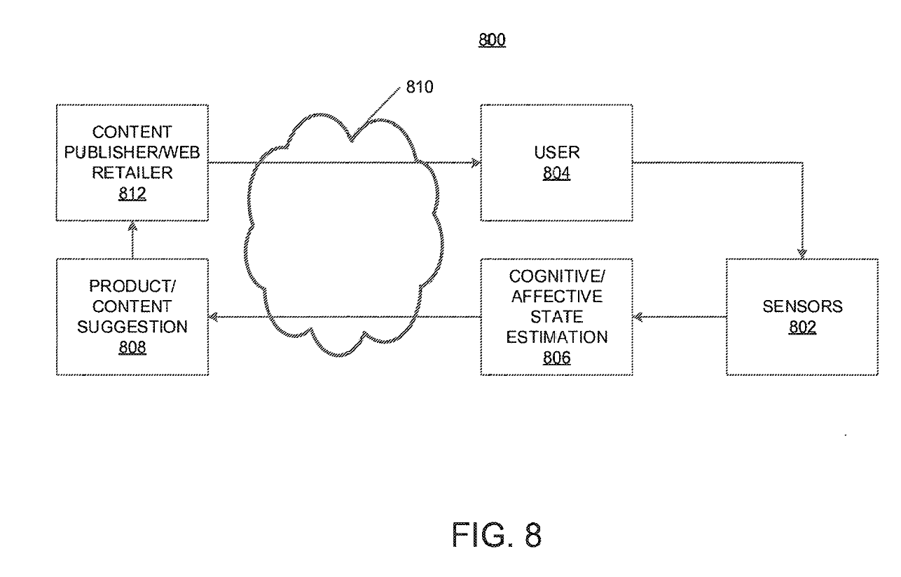

FIG. 8 is a block diagram illustrating an example flow of information in an example affective- and/or cognitive-adaptive product suggestion system 800. One or more sensors 802 may generate data (e.g., sensor data) associated with a user 804. The one or more sensors 802 may provide the data for a cognitive/affective state estimation. The cognitive/affective state estimation, at 806 may estimate (e.g., determine) a cognitive and/or affective state of the user based on the data. The cognitive and/or affective state of the user may be provided for a product/content suggestion. The cognitive and/or affective state of the user may be provided for the product/content suggestion, via a network 810. At 808, one or more products or content may be determined or selected for delivery to the user based on the cognitive and/or affective state of the user. The product/content suggestion may determine one or more products or content based on one or more products or content that has historically elicited similar responses in audiences, in other users, in similar users, or in the current user. The one or more products or content information determined by the product/content suggestion may be provided to a content publisher or a retailer 812. The content publisher or the retailer 812 may deliver an advertisement for the one or more products or the content selected for delivery to the user 804. The affective- and/or cognitive-adaptive product suggestion system 800 may be implemented using a system architecture such as the systems depicted in FIG. 1C through FIG. 1E. For example, the advertisement and/or the content may be delivered to the user via a WTRU 102 (e.g., a smart phone handset or a tablet computer, etc.) as depicted in FIG. 1C through FIG. 1E.

An affective- and/or cognitive-adaptive product suggestion system may track a cognitive and/or affective state of a user as the user consumes content (e.g., an advertisement). The affective- and/or cognitive-adaptive product suggestion system may categorize the cognitive and/or affective state of the user as the user consumes content. The affective- and/or cognitive-adaptive product suggestion system may categorize one or more stimulus/response pairs based on the cognitive and/or affective state of the user as the user consumes content. The stimulus in a stimulus/response pair may include information presented to the user (e.g., content). The response in the stimulus/response pair may include a cognitive state and/or an affective state of the user in response to the information presented to the user. The user may be associated with a customer category based on the one or more stimulus/response pairs. The one or more stimulus/response pairs may indicate how the content or product made the user feel. The one or more stimulus/response pairs may be stored in a database. The user may be associated with a customer category based on the one or more stimulus/response pairs. An advertisement may be selected for delivery to the user based on the customer category associated with the user. The affective- and/or cognitive-adaptive product suggestion system may observe how the user responds to different content or products and, over time, develop a stimulus response model. The stimulus response model may be based on historical user responses to one or more prior advertisements. The stimulus response model may be used to categorize one or more preferences of the user. The stimulus response model may be used to select an advertisement for delivery to the user. The stimulus response model may select an advertisement for delivery to the user based on one or more previous responses by the user to one or more advertisements for one or more products. For example, a first advertisement for a first product may be selected for delivery to the user based on a previous response of the user to a second advertisement for a second product.

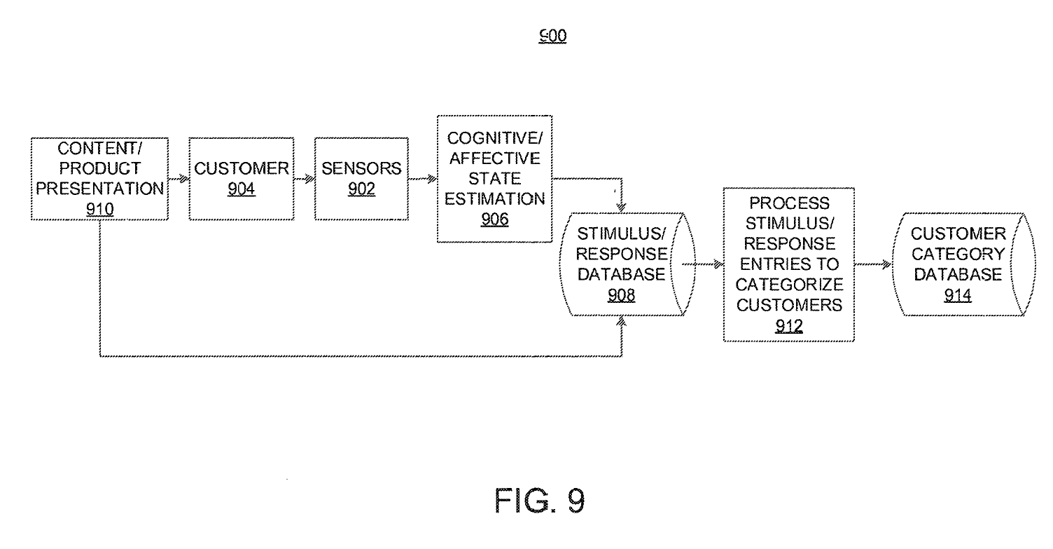

FIG. 9 is a block diagram illustrating an example customer categorization subsystem 900 that may be used by or in conjunction with a product suggestion system, such as the affective- and/or cognitive-adaptive product suggestion system 800. One or more sensors 902 may generate data (e.g., sensor data) associated with a user 904 when the user 904 is presented with content and/or product information 910. The one or more sensors 902 may provide the data to a cognitive/affective state estimation subsystem 906. The cognitive/affective state estimation subsystem 906 may use the data to determine (e.g., estimate) a cognitive and/or affective state of the user 904. The cognitive/affective state estimation subsystem 906 may provide the determined cognitive and/or affective state of the user 904 to a stimulus/response database 908. The cognitive/affective state estimation subsystem 906 may combine the determined cognitive and/or affective state of the user 904 with content and/or product information 910. The customer categorization subsystem 900 may process stimulus/response entries to associate the user 904 with a customer category at 912. The customer category may be a predefined customer category. The customer categorization subsystem 900 may store categorization information, one or more predefined customer categories, and/or one or more stimulus/response pairs in a customer category database 914. The customer category database 914 may be a stimulus response database.

For example, a user may be placed in (e.g., associated with) a category associated with enjoying certain content or products and being unhappy with other content or products. Content (e.g., specific content) and/or one or more products that are widely consumed (e.g., popular content and/or popular products) may be used as markers for user affinity. The content and/or one or more products that are widely consumed may be used to associate one or more advertisements with one or more customer categories. One or more advertisement selections (e.g., product suggestions) may be determined based on a stimulus/response pair (e.g., by extrapolating one or more positive responses) from one or more other users in the same or a similar customer category.

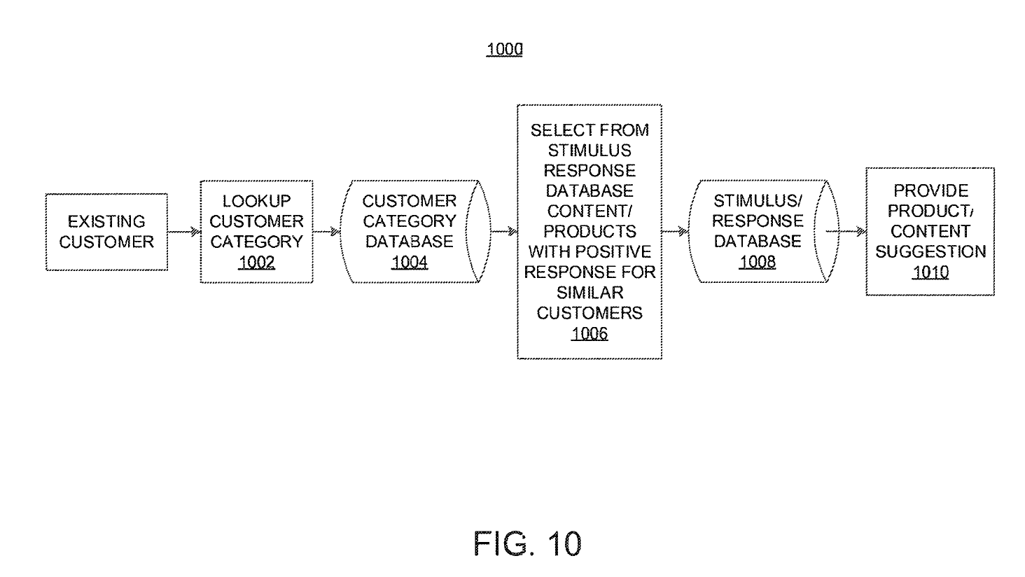

FIG. 10 is a block diagram illustrating an example product/content suggestion subsystem 1000. The example product/content suggestion subsystem 1000 may be used by or in conjunction with a product suggestion system, such as the affective- and/or cognitive-adaptive product suggestion system 800. The product/content suggestion subsystem 1000 may determine (e.g., look up) a customer category at 1002 for a customer. The product/content suggestion subsystem 1000 may determine the customer category for the customer for a customer from a customer category database 1004. At 1006, the product/content suggestion subsystem 1000 may select content and/or one or more advertisements for a product or products from a stimulus/response database 1008. The selected content and/or the one or more advertisements may be selected based on having historically elicited positive responses from similar customers (e.g., customers in the same customer category as the customer). At 1010, the product/content suggestion subsystem 1000 may deliver (e.g., provide) an advertisement for a selected product and/or content (e.g., suggestion) to the customer. The product/content suggestion subsystem 1000 may be implemented using a system architecture such as the systems depicted in FIG. 1C through FIG. 1E. For example, the advertisement and/or the content may be delivered to the customer via a WTRU 102 (e.g., a smart phone handset or a tablet computer, etc.) as depicted in FIG. 1C through FIG. 1E.

An affective- and/or cognitive adaptive product suggestion system, such as the affective- and/or cognitive-adaptive product suggestion system 800, may indicate that a user who watched a first content or advertisement and/or bought a first product may be interested in a second content and/or a second product. A person that watched and/or bought the first content and/or the first product may not have enjoyed or been pleased with the first content and/or the first product. A user who watched and/or bought the first content and/or the first product may not be pleased with the second content and/or the second product.

By monitoring the affective and/or cognitive state of the user, an affective- and/or cognitive-adaptive product suggestion system (e.g., the affective- and/or cognitive-adaptive product suggestion system 800) without the need for explicit user feedback, may be able to indicate (e.g., report) to a user that one or more users with similar tastes or interests who enjoyed or were pleased with a first content and/or first product have also enjoyed or were also pleased with a second content and/or a second product. The affective- and/or cognitive-adaptive product suggestion system may not require (e.g., avoid the need for) explicit user feedback. The affective- and/or cognitive-adaptive product suggestion system may provide a faster (e.g., more immediate) and/or more direct measure of consumer satisfaction. For example, a user may not be consciously aware of an enjoyment level of the user. As another example, the user may be influenced by one or more transient events, which may not affect a user assessment of the user experience.

Affective and/or cognitive state may be used for human-machine-machine-human interactions, such as video chat. Affective and/or cognitive analysis of one or more participants may be performed in a real-time video chat (e.g., video call) between two or more participants. The affective and/or cognitive analysis of the one or more participants may provide information to one or more participants to enhance the flow and/or content of information. The affective and/or cognitive analysis may determine a cognitive state of one or more participants and/or an affective state of the one or more participants based on sensor data. Affective and/or cognitive state analysis may assist in interpersonal relationships. For example, a participant in a conversation may offend (e.g., unknowingly offend) another participant. When affective state analysis is performed, an interaction between two or more participants may be improved (e.g., and issues may be dealt with rather than leaving them unaddressed). A user interface on an end (e.g., each end) of the real-time video chat may incorporate cognitive and/or affective state analysis. A user video stream may be processed for cognitive and/or affective state analysis at a client (e.g., each client) or in a central server that processes the session video (e.g., the one or more session video streams).

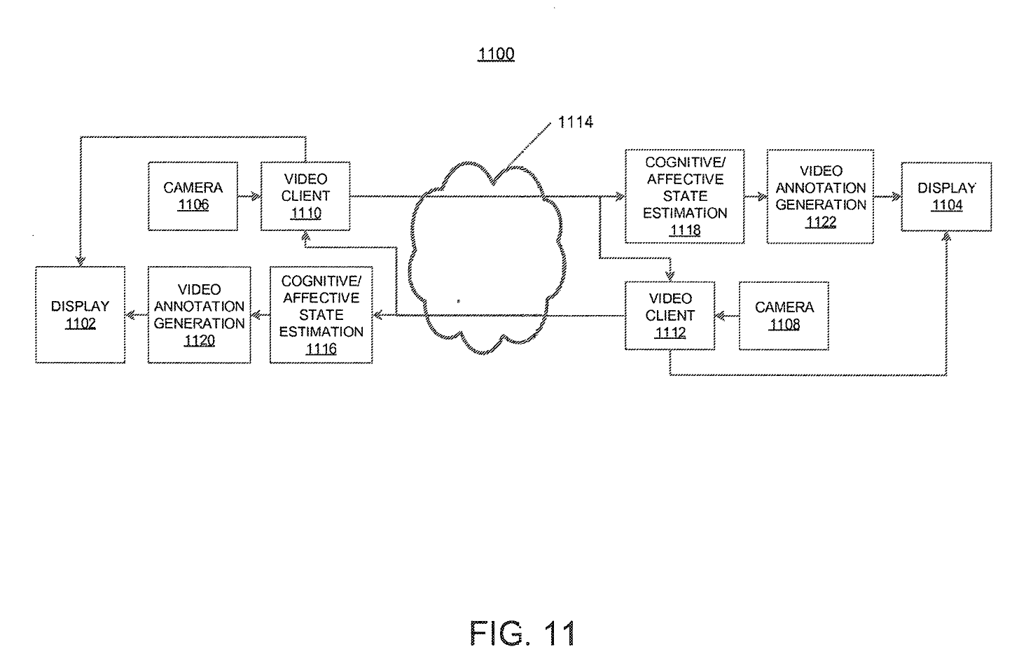

FIG. 11 is a block diagram illustrating an example affective- and/or cognitive-adaptive video chat system 1100. The affective- and/or cognitive-adaptive video chat system 1100 may include one or more displays 1102, 1104 and one or more cameras 1106, 1108. One or more video clients 1110, 1112 may communicate with each other via a network 1114, such as the Internet. The one or more cameras 1106, 1108 and/or other sensors (not shown in FIG. 11) may provide data to one or more cognitive/affective state estimation subsystems 1116, 1118. The one or more cognitive/affective state estimation subsystems 1116, 1118 may determine (e.g., estimate) a cognitive and/or affective state of a remote participant. For example, the cognitive/affective state estimation subsystem 1116 may use data from a camera 1106 to determine (e.g., estimate) a cognitive and/or affective state of a participant located proximate to the camera 1106. The cognitive/affective state estimation subsystem 1118 may use data from a camera 1108 to determine (e.g., estimate) a cognitive and/or affective state of a participant located proximate to the camera 1108. The cognitive/affective estimation subsystems 1116, 1118 may provide the determined cognitive and/or affective state information to respective video annotation generation subsystems 1120, 1122. The respective video annotation generation subsystems 1120, 1122 may generate one or more annotations (e.g., one or more video annotations) to be displayed using the displays 1102, 1104, respectively. The affective- and/or cognitive-adaptive video chat system 1100 may be implemented using a system architecture such as the systems depicted in FIG. 1C through FIG. 1E. For example, the one or more displays 1102, 1104 may include a WTRU 102 (e.g., a smart phone handset or a tablet computer, etc.) as depicted in FIG. 1C through FIG. 1E.

Examples of a video annotation may include an indication, to a first party, that a second party (e.g., the other party) in a call may be confused and/or may desire clarification or reiteration. For example, the second party may desire additional time before continuing the discussion (e.g., while processing information). The second party may be offended and may desire an apology or other form of reconciliation. The second party may be overloaded and may desire a pause or break from the conversation. The second party may be detached (e.g., may not be paying attention). A cognitive/affective estimation subsystem may determine (e.g., estimate) that the other party may be deceptive based, for example, on facial expressions and/or cognitive and/or affective analysis. When a party is determined to be deceptive, the cognitive/affective estimation subsystem may indicate that the party is being deceptive and that the party be handled with caution (e.g., be wary of responses provided by the party, be alert for any deceptive tactics, etc.).

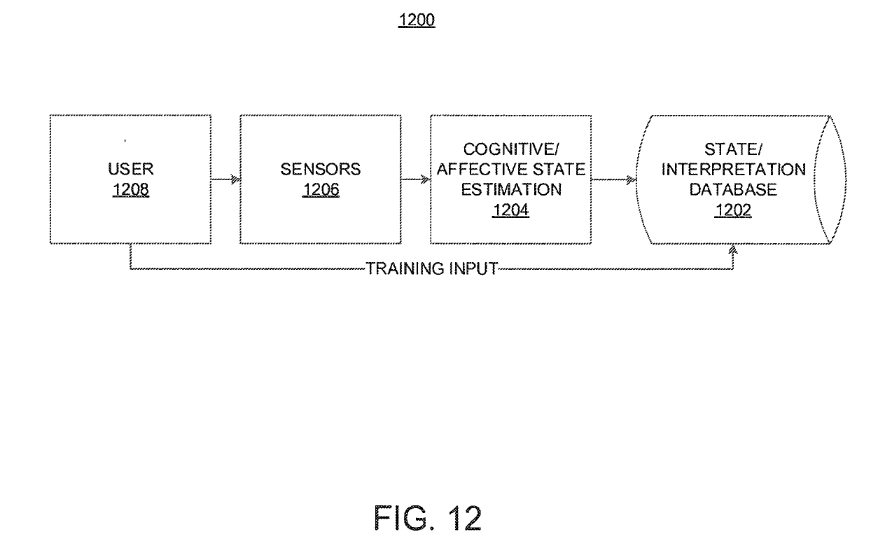

An interpretation may be performed. The interpretation may be performed by leveraging one or more reference pairs of cognitive and/or affective state and/or one or more interpretations to provide interpretations of the cognitive and/or affective state to one or more users. FIG. 12 is a block diagram illustrating an example subsystem 1300 that may populate a state/interpretation database 1202 with training data. The training data may link one or more cognitive and/or affective states with one or more interpretations (e.g., offended, bored, deceptive, confused, etc.). A cognitive/affective state estimation subsystem 1204 may receive data from one or more sensors 1206. The one or more sensors 1206 may capture, for example, one or more images and/or biometric data associated with a user 1208. The one or more images and/or biometric data from the user 1208 may include, e.g., speech analysis, facial expression analysis, body language analysis, eye motion/gaze direction analysis, blink rate analysis, and/or the like. The cognitive/affective state estimation subsystem 1204 may determine (e.g., estimate) a cognitive and/or affective state of the user 1208. The cognitive/affective state estimation subsystem 1204 may determine the cognitive and/or affective state of the user 1208 based on the one or more images and/or biometric data. The cognitive/affective state estimation subsystem 1204 may populate the state/interpretation database 1202 with the determined cognitive/affective state of the user 1208.

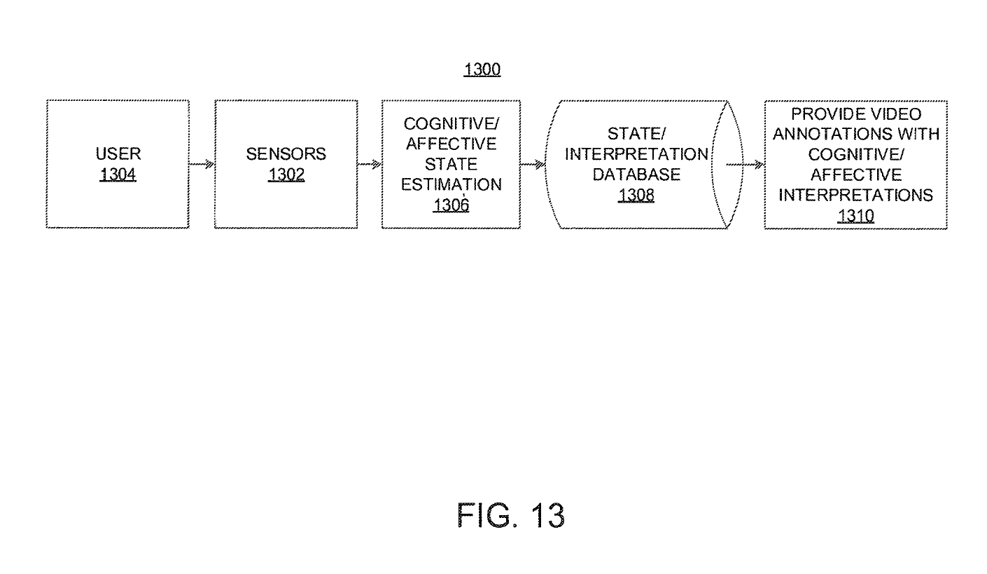

FIG. 13 is a block diagram illustrating an example video annotation generation subsystem 1300. One or more sensors 1302 may capture one or more images and/or biometric data associated with a user 1304. The one or more images and/or biometric data may include, e.g., speech analysis, facial expression analysis, body language analysis, eye motion/gaze direction analysis, blink rate analysis, and/or the like. The one or more sensors 1302 may provide the one or more images and/or biometric data to a cognitive/affective state estimation subsystem 1306. The cognitive/affective state estimation subsystem 1306 may determine (e.g., estimate) a cognitive and/or affective stale of the user 1304. The cognitive/affective state estimation subsystem 1306 may determine the cognitive and/or affective state of the user 1304 based on the one or more images and/or biometric data. One or more cognitive and/or affective interpretations may be generated via a state/interpretation database 1308. At 1310, the video annotation generation subsystem 1300 may provide one or more video annotations that may indicate the one or more cognitive and/or affective interpretations.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

1. A method for managing a content placement in a human machine interface (HMI), the method comprising:
receiving sensor data from one or more sensors;
determining, based on the received data, a cognitive state of a user;
determining a timing for delivery of content based on the determined cognitive state of the user such that the content is delivered to the user when a cognitive load of the user is below a predetermined threshold; and
delivering, via the HMI, the content to the user based on the determined timing.

2. The method of claim 1, wherein the sensor data comprises at least one of camera data, galvanic skin response (GSR) data, voice analysis data, facial expression analysis data, body language analysis data, eye movement and gaze tracking analysis data, blink rate analysis data, electroencephalographic data, electrodermal activity data, pupillometry data, heart rate data, blood pressure data, respiration rate data, or body temperature data

3. The method of claim 1, wherein the cognitive state of the user comprises a current cognitive load of the user.

4. The method of claim 1, further comprising:
determining, based on the received data, an affective state of the user; and
determining a timing for delivery of content based on the determined affective state of the user such that the content is delivered to the user when the affective state of the user indicates that the user is receptive;
wherein the affective state of the user comprises an arousal measure and a valance measure.

5. The method of claim 4, wherein the affective state of the user indicates that the user is receptive when a distance measure from the affective state of the user to a predefined affective state is below a predetermined threshold, and wherein the predefined affective state comprises a predefined arousal measure and a predefined valance measure, and wherein the distance measure is based on a distance between the affective state of the user and the predefined affective state, and wherein the distance measure comprises an arousal measure and a valance measure.

6. The method of claim 4, further comprising selecting the content for delivery to the user based on at least one of the cognitive state of the user or the affective state of the user.

7. The method of claim 1, further comprising selecting the content for delivery to the user based on a stimulus response model for the user based on historical user responses to prior content.

8. The method of claim 1, further comprising selecting the content for delivery to the user based on a stimulus response database of customers in a predefined customer category that includes the user.

9. The method of claim 4, further comprising:
associating the user with a customer category based on a stimulus/response pair had on information presented to the user and at least one of the cognitive state or the affective state of the user in response to the information presented; and
selecting the content for delivery to the user based on the customer category associated with the user.

10. The method of claim 1, wherein the content is a first advertisement for a first product, further comprising selecting the first advertisement for delivery to the user based on a previous response of the user to a second advertisement for a second product.

11. The method of claim 4, wherein the content is a first content, the method further comprising:
delivering, via the HMI, a second content to the user, wherein the second content comprises at least one of video data, video game data, educational data, or training data; and
storing a stimulus/response pair based on the second content delivered to the user and at least one of the cognitive state or the affective state of the user in response to the second content delivered to the user.

12. The method of claim 4, wherein determining the at least one of a cognitive state of a user or an affective state of the user comprises:
analyzing die received sensor data;
plotting an arousal measure and a valence measure on a two-dimensional arousal valence space; and
associating the user with one or more predefined affective states based on the plotting.

13. The method of claim 1, wherein the content comprises an advertisement.

14. A system configured to manage a content placement in a human machine interface (HMI), the system comprising:
a processor configured at least in part to:
receive sensor data from one or more sensors;
determine, based on the received sensor data, a cognitive state of a user;
determine a timing for delivery of content based on the determined cognitive state of the user such that the content is delivered to the user when a cognitive load of the user is below a predetermined threshold; and
deliver, via the HMI, the content to the user based on the determined timing.

15. The system of claim 14, wherein the sensor data comprises at least one of camera data, galvanic skin response (GSR) data, voice analysis data, facial expression analysis data, body language analysis data, eye movement and gaze tracking analysis data, blink rate analysis data, electroencephalographic data, electrodermal activity data, pupillometry data, heart rate data, blood pressure data, respiration rate data, or body temperature data.

16. The system of claim 14, wherein the cognitive state of the user comprises a current cognitive load of the user.

17. The system of claim 14, further comprising:
a processor configured at least in part to:
determine, based on the received sensor data, an affective state of the user;
determine a timing for delivery of content based on the determined affective state of the user such that the content is delivered to the user when the affective state of the user indicates that the user is receptive;
wherein the affective state of the user comprises an arousal measure and a valance measure.

18. The system of claim 17, wherein the affective state of the user indicates that the user is receptive when a distance measure from the affective state of the user to a predefined affective state is below a predetermined threshold, and wherein the predefined affective state comprises a predefined arousal measure and a predefined valance measure, and wherein the distance measure is based on a distance between the affective state of the user and the predefined affective state, and wherein the distance measure comprises an arousal measure and a valance measure.

19. The system of claim 17, wherein the processor is further configured to select the content for delivery to the user based on at least one of the cognitive state of the user or the affective state of the user.

20. The system of claim 14, wherein the processor is further configured to select the content for delivery to the user based on a stimulus response model for the user based on historical user responses to prior content.

21. The system of claim 14, wherein the processor is further configured to select the content for delivery to the user based on a stimulus response database of customers in a predefined customer category that includes the user.

22. The system of claim 17, wherein the processor is further configured to:
associate the user with a customer category based on a stimulus/response pair based on information presented to the user and at least one of the cognitive state or the affective state of the user in response to the information presented; and
select the content for delivery to the user based on the customer category associated with the user.

23. The system of claim 14, wherein the content is a first advertisement for a first product, and wherein the processor is further configured to select the first advertisement for delivery to the user based on a previous response of the user to a second advertisement for a second product.

24. The system of claim 17, wherein the content is a first content, and wherein the processor is further configured to:
deliver, via the HMI, content to the user, wherein the content comprises at least one of video data, video game data, educational data, or training data; and
store a stimulus/response pair based on the content delivered to the user and at least one of the cognitive state or the affective state of the user in response to the content delivered to the user.

25. The system of claim 17, wherein the processor configured to determine the at least one of a cognitive state of a user or an affective state of the user comprises the processor further configured to:
analyze the received sensor data;
plot an arousal measure and a valence measure on a two-dimensional arousal valence space; and
associate the user with one or more predefined affective states based on the plot.

26. The system of claim 14, wherein the content comprises an advertisement.
